(19) United States
(12) Patent Application Publication
(10) Pub. No.: US 2015/0068042 A1
(43) Pub. Date: Mar. 12, 2015

(54) PIERCING TOOL AND PROCESS FOR FORMING AIRBAG TEAR SEAMS

(71) Applicant: Faurecia Interior Systems, Inc., Auburn Hills, MI (US)

(72) Inventors: Michael Twork, White Lake, MI (US); Mathew Barr, Clarkston, MI (US)

(73) Assignee: Faurecia Interior Systems, Inc., Auburn Hills, MI (US)

(21) Appl. No.: 14/020,588

(22) Filed: Sep. 6, 2013

(51) Int. Cl. B60R 21/2165; B26D 3/08

(52) U.S. Cl. CPC B60R 21/2165; B26D 3/085
USPC 29/897.2; 83/866

(57) ABSTRACT

A non-visible tear seam can be formed in a vehicle interior panel in a mechanical piercing process with a piercing tool that radially supports a needle during the process. The radial support enables the use of higher gauge needles and the formation of non-visible microholes through a visible surface of the panel. The piercing tool is capable of forming each of the microholes of the tear seam individually and may be disposable and/or may be configured with a replaceable needle.

### TECHNICAL FIELD

The present disclosure relates generally to vehicle interior panels for use over airbags and, more particularly, to tear seams formed in vehicle interior panels.

### BACKGROUND

Vehicle airbags are safety devices that deploy toward the interior of a vehicle to help protect its occupants from injury in the event of a crash. Airbags may be concealed behind or beneath an interior panel during normal vehicle operation until such an event. When the airbag deploys, it typically does so through a deployment opening formed in or around the interior panel. The deployment opening may be pre-formed in the panel, the panel may move away to reveal the opening, or the opening may be formed during airbag deployment at a pre-determined location in the panel. Where formed during airbag deployment, a tear seam may be provided in one or more components of the panel to at least partly define the location of the opening. Early airbag doors or tear seams were usually visible from the interior of the vehicle, but efforts have since been made to make tear seams non-visible from the interior of the vehicle for aesthetic purposes. Non-visible tear seams are usually formed with cuts, grooves, notches, scores, or other types of stress concentrators in a non-visible surface of one or more layers of the interior panel.

German patent DE 4411283 to Stückle et al. describes one method of forming a tear seam that includes stitching an outer foil to hold the outer foil in place over the airbag. The needle used to apply the stitching perforates the outer foil along a groove or ditch in the outer foil to form a visible, stitched tear line. The foil is heated along the stitched tear line to shrink the perforations, and then cooled rapidly. The heating is intended to make the perforations less visible, but the groove and the stitching remain as visual evidence of the tear seam location.

### SUMMARY

In accordance with one or more embodiments, a method of making a vehicle interior panel for use over an airbag includes the steps of: (a) providing a decorative covering having a decorative skin layer; (b) forming a plurality of microholes through the decorative skin layer along a pre-determined tear seam location using a piercing tool that includes an individually extendable and retractable 26-gauge or higher gauge needle; (c) radially supporting the needle during microhole formation with a housing so that, during formation of each one of the microholes, the housing is in contact with the decorative covering and needle movement is restricted to axial movement; and (d) disposing the decorative covering over a vehicle interior panel substrate.

According to one or more additional embodiments, the piercing tool includes only one needle, and the same needle is used to form all of the microholes in the decorative covering along the tear seam location.

According to one or more additional embodiments, step (d) is performed before steps (b) and (c).

According to one or more additional embodiments, a face of the housing is in contact with the decorative covering during step (b) and the housing limits the amount of axial extension of the needle beyond the face of the housing.

According to one or more additional embodiments, the piercing tool is attached to a piercing system via a biased attachment including a spring, and the method further includes the step of compressing the spring while the needle is at the limit of axial extension beyond the face of the housing.

According to one or more additional embodiments, step (d) is performed after steps (b) and (c), and the decorative covering is flat during steps (b) and (c).

According to one or more additional embodiments, the needle is a 33-gauge or higher gauge needle.

According to one or more additional embodiments, the method includes the step of replacing the needle with an unused needle before steps (b) and (c) if the needle has been previously used to form a plurality of microholes along the tear seam location of a quantity of other decorative coverings, wherein the quantity is in a range from 1 to 200.

In accordance with one or more embodiments, a piercing tool for use in forming a tear seam in a vehicle interior panel includes a needle mount and a needle. The needle has a piercing end and an opposite mounting end, and each of the ends is arranged along an axis of the needle. The mounting end of needle is attached to the needle mount so that the needle mount and the needle move together. The piercing tool also includes a housing coupled with the needle mount for relative axial movement with respect to the needle mount between a retracted configuration and an extended configuration. The piercing end of the needle is inside the housing in the refracted configuration, and the piercing end of the needle is outside the housing in the extended configuration. The housing is configured to radially support the needle during movement between the retracted and extended configurations. A dedicated spring biases the needle mount toward the retracted configuration.

According to one or more additional embodiments, the needle is a 26-gauge or higher gauge needle.

According to one or more additional embodiments, the needle is a 33-gauge or higher gauge needle.

According to one or more additional embodiments, the spring is coaxial with the needle.

According to one or more additional embodiments, the housing is in contact with the needle mount at a first stop in the extended configuration, and the housing is in contact with the needle mount at a second stop in the refracted configuration. The axial spacing between the first and second stops defines the amount of allowable axial needle movement.

According to one or more additional embodiments, the housing is coupled with the needle mount in a snap-fit configuration that includes a plurality of separately flexible fingers spaced about the axis of the needle, wherein the plurality of fingers provides one of said stops.

According to one or more additional embodiments, the plurality of fingers is configured so that the needle mount and needle can be removed and replaced with a different needle mount and needle.

According to one or more additional embodiments, the needle includes a compound chamfer and a solid cross-section.

Within the scope of this application it is envisaged that the various aspects, embodiments, examples, features and alternatives set out in the preceding paragraphs, in the claims and/or in the following description and drawings may be taken independently or in any combination thereof. For example, features disclosed in connection with one embodiment are applicable to all embodiments, except where there is incompatibility of features.

### DESCRIPTION OF THE DRAWINGS

One or more embodiments will hereinafter be described in conjunction with the appended drawings, wherein like designations denote like elements, and wherein:

FIG. 1 is a partial cutaway view of an example of a vehicle interior panel including a tear seam;

FIG. 2 is a side cross-sectional view of the vehicle interior panel of FIG. 1, shown with an embodiment of a piercing tool in a retracted configuration (A) and an extended configuration (B) as the piercing tool may be positioned during an exemplary piercing process;

FIG. 3 is an exploded view of the piercing tool of FIG. 2;

FIG. 4 is an enlarged version of the cross-sectional view of the piercing tool of FIG. 2, shown in the retracted configuration;

FIG. 5 is a schematic illustration of the piercing tool during a piercing process, where the piercing tool is rigidly attached to a piercing system; and

FIG. 6 is a schematic illustration of the piercing tool during a piercing process, where the piercing tool is attached to the piercing system with a biased attachment.

### DETAILED DESCRIPTION OF EMBODIMENT(S)

As described below, a non-visible tear seam can be formed in a vehicle interior panel by piercing through the visible decorative surface of the panel. The holes formed by the piercing tool, and by the method described herein, are not visible to the naked eye. The piercing tool may include a 26-gauge or higher gauge needle and is configured to provide radial support along the needle to prevent bending or buckling of the needle, which can be a significant problem with high gauge needles. The piercing tool may operate to pierce the skin layer with only a single needle at any one time, advantageously reducing the required piercing force compared to multi-needle piercing tools, and can be constructed as a disposable tool or in a manner that allows frequent and cost-effective needle replacement.

Referring now to FIG. 1, a cut-away view of an illustrative vehicle interior panel 10 is shown with an airbag module 12 installed therebeneath. The panel 10 includes a plurality of material layers, and each layer may include its own separately weakened portion or tear seam for the formation of a deployment opening during airbag deployment. The portion of the panel 10 shown in FIG. 1 is the passenger side of an instrument panel and includes a substrate 14, a decorative covering 16, and a non-visible tear seam 18. The tear seam 18 is arranged along a line or path that at least partly defines the location of the airbag deployment opening and includes features that concentrate stress in the desired panel layer(s) along the line or path so that force applied to the panel by an inflating airbag breaks or tears the panel therealong. The illustrated tear seam 18 is generally U-shaped, but it may be formed in other shapes, such as a rectangle, H-shape, or X-shape, to name a few examples. This disclosure is also applicable to other types of vehicle interior panels for use over airbags, such as door panels, seat panels, steering wheel panels, pillar panels, or headliner panels, to name a few.

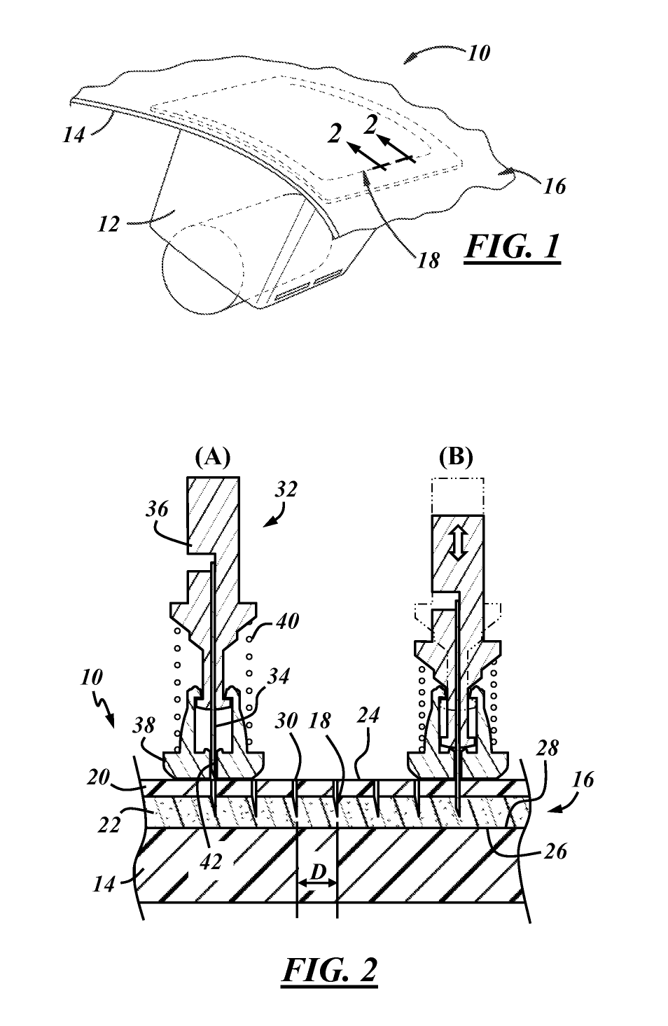

FIG. 2 is a cross-section of the vehicle interior panel 10 along the tear seam 18, shown as it may be arranged during a mechanical piercing process, which is subsequently described in further detail. The decorative covering 16 is disposed over the substrate 14 to at least partly form the panel 10, though the panel may include other components or layers not shown here. The covering 16 may be disposed over the substrate 14 either before or after the piercing process is performed, or piercing processes may be performed both before and after the covering is disposed over the substrate. The substrate 14 may provide the basic shape and/or support structure for the panel 10 and can be constructed from nearly any material or combination of materials, including metals, plastics, or composite type materials such as reinforced or filled thermoplastic materials. Polypropylene or other olefin-based plastics having 15-30% glass fiber reinforcement are examples of suitable substrate materials. The substrate 14 may have an airbag deployment opening pre-formed therethrough, an airbag door at least partly defined by a slot formed through and along the substrate in the desired shape, or a tear seam along which the deployment opening is formed during airbag deployment.

The decorative covering 16 provides a desired aesthetic for the vehicle interior panel 10 and includes one or more material layers. In the embodiment of FIG. 2, the covering 16 has a bi-layer construction and includes a skin layer 20 overlying an inner layer 22. The skin layer 20 provides the panel 10 with the desired appearance and tactile feel at a visible outer surface 24, and the inner layer 22 may be provided to enhance the tactile feel of the panel by providing a cushion-like effect when a passenger touches the panel. The skin layer 20 may be constructed from any of a variety of materials and may range in thickness from about 0.3 mm to about 1.5 mm. In one embodiment, the skin layer 20 is a self-healing skin layer as described in international patent application publication number WO 2013/089994, which is hereby incorporated by reference in its entirety. Certain TPO skin layer materials may be self-healing materials, for example. The present disclosure is applicable to all types of skin layers, including synthetic materials such as polymers and natural materials such as leather.

The inner layer 22 may be a polymeric foam material such as polypropylene foam or other olefin-based foam. In one embodiment, the thickness of the inner layer 22 is in a range from 0.5 mm to 5.0 mm depending on the desired amount of cushioning or other factors. The inner layer 22 can also be made from other types of foam materials, felt, batting, spacer fabric, or natural or synthetic textile materials, for example. Each of the layers 20, 22 can serve other functions as well, and additional layers of material may be included in the decorative covering 16, such as additional padding, foam, adhesive, or surface finish layers. In one embodiment, the skin layer 20 alone is the covering. In another embodiment, the skin layer 20 and the inner layer 22 are laminated together and provided together as the decorative covering 16 to be disposed over and attached to a separately provided substrate 14, with an inner surface 26 of the covering 16 provided by the inner layer 22 and in contact with an outer surface 28 of the substrate. The covering 16 may be attached to the substrate 14 by any suitable method, such as adhesive attachment, lamination, or wrapping the covering around substrate edges for attachment to an underside of the substrate. In other embodiments, the panel 10 includes a slush molded skin layer 20 and/or includes a foam inner layer 22 that is formed in place by filling a space between the skin layer and the substrate with an expandable foam composition.

With continued reference to FIG. 2, there is shown a portion of a method of making the vehicle interior panel 10. The method includes the steps of providing the decorative covering 16, forming a plurality of microholes 30 through the decorative skin layer 20 along a pre-determined location for the tear seam 18 with a piercing tool 32 that includes a needle 34, and disposing the decorative covering over the substrate 14. In the illustrated embodiment, the decorative covering 16 is disposed over the substrate before forming the microholes 30. In another embodiment, the microholes 30 are formed through the skin layer 20 in a separately provided decorative covering 16 before the covering is disposed over the substrate 16. For instance, the piercing process may be performed on a bi-layer covering while in flat form, a decorative covering that has been thermoformed, or a slush molded skin layer already formed to shape.

As used herein, a microhole 30 is a hole with an effective diameter or other characteristic size that is small enough to be visually undetectable. This characteristic size may vary depending on factors such as the color or roughness of the outer surface 24 of the skin layer 20 or other factors. It has been found that holes with an effective diameter of about 0.3 mm or less are sufficiently small to be undetectable at normal vehicle interior viewing distances in a typical skin layer material. But, as already noted, this threshold value may vary, and smaller holes are generally less visible than larger ones. A 26-gauge or higher gauge needle 34 is capable of forming microholes 30 in many skin layer materials. In one embodiment, the needle 34 is a 33-gauge needle. For purposes of this disclosure, needle gauges are specified according to the Stubs Iron Wire Gauge system, where increasing gauge corresponds to decreasing diameter. A 26-gauge needle has an outer diameter of 0.46 mm and a 33-gauge needle has an outer diameter of 0.21 mm.

Adjacent microholes 30 are spaced apart along the tear seam 18 by a distance D, which may be constant or variable among the plurality of microholes. The distance D may range from 0.5 to 3.0 mm, and is preferably about 1.0 mm. This hole-to-hole spacing is less than in typical laser-formed tear seams, particularly in decorative coverings that include a polymeric foam layer, as laser processes can burn away some of the polymeric foam material on the backside of the covering and thus cannot be spaced as closely and remain non-visible at the visible surface. The lower hole-to-hole spacing D possible with mechanical piercing can improve tear seam function, as there is less skin layer material between the adjacent holes 30 with a smaller spacing D.

The illustrated piercing tool 32 includes the needle 34, a needle mount 36, a housing 38, and a spring 40. FIG. 2 illustrates the piercing tool 32 in a retracted configuration (A) and an extended configuration (B) at two different locations along the covering 16. In the retracted configuration, a piercing end 42 of the needle 34 is inside the housing 38. In the extended configuration, the piercing end 42 of the needle is outside the housing 38. The piercing tool 32 is first brought into contact with the decorative covering 16 in the retracted configuration, at the visible outer surface 24 of the skin layer 20 in this example. Alternatively, the piercing tool may be brought into contact with the opposite, non-visible surface 26 of the decorative covering when the piercing process is performed on the decorative covering 16 before it is disposed over the substrate 14. A force is then applied to the needle mount 36 to move the needle 34 and the needle mount 36 relative to the housing 38 against the bias of the spring 40. The piercing end 42 of the needle 34 breaks through the outer surface 24 of the skin layer 20 and continues through the entire thickness of the skin layer. When the applied force is removed, the bias of the spring 40 returns the piercing tool 32 to the retracted position, leaving the microhole 30 formed through the skin layer 20. Each microhole 30 may extend at least partially through the inner layer 22 as well. As described further below, the piercing tool 32 can be configured to limit the amount of axial extension of the needle 34 from the housing 38, which can help prevent contact between the needle and the substrate 14 or other underlying support fixture. This is especially advantageous where the needle 34 is a 26-gauge or higher gauge needle and thus easily bent or damaged when encountering resistance to movement while outside of the housing 38.

It has been found that forming each of the microholes 30 of the tear seam 18 individually, as shown—that is, with only a single needle 34 piercing the skin layer 20 at one time—is advantageous to reduce the overall visibility of the resulting tear seam 18. For instance, piercing processes in which multiple needles press against the decorative covering 16 at the same time require higher piercing forces—i.e., pressing 10 needles through the skin layer 20 requires approximately 10 times the force. Though the force may be divided among the multiple needles in such cases, the proximity of the multiple needles to one another can result in the full force being concentrated in a relative small region of the covering (along the tear seam). Even if the individual holes formed in such a process are non-visible microholes, the high stresses applied along the tear seam during formation can cause the location of the tear seam to become apparent where the skin layer material is stressed and/or stretched during the piercing process. In one embodiment, each one of the microholes 30 of the tear seam 18 is formed by the same piercing tool 32 and the same needle 34. In another embodiment, multiple piercing tools 32 are used to individually form each microhole 30. For example, a plurality of piercing tools 32, each with its own spring-loaded needle 34 and housing 38, may be located along the decorative covering 16 at the desired tear seam location and sequentially actuated or otherwise pressed through the skin layer 20 one at a time so that a single piercing tool does not have to be moved to each and every desired microhole location. In another example, the piercing tool 32 is constructed with a single housing 38 and includes a plurality of individually operable needles 34, each with a dedicated spring 40.

The piercing tool 32 is configured to radially support the needle 34 while moving between the retracted and extended configurations. The housing 38 is in contact with the outer surface 24 of the covering 16 during the full range of axial needle movement so that none of the piercing end 42 of the needle is ever exposed—i.e., the piercing end of the needle is located in the housing or within the thickness of the covering at all times. Where the needle gauge is 26-gauge or higher, and particularly where the needle gauge is 30-gauge or higher, even a very small side load on the needle—on the order of hundredths of a pound—can cause a radially unsupported needle to deflect enough that any additional applied axial force will plastically deform the needle, rendering it useless to form the microholes 30. This problem has limited the practical use of needles in piercing processes to form tear seams to needle gauges that are lower than 26-gauge, which are only capable of forming visible holes in most decorative covering materials. The piercing tool 32 described herein thus enables the use of previously unusable needles in tear seam forming processes and eliminates the need for post-processes, such as heating, intended to shrink or otherwise hide mechanically pierced holes.

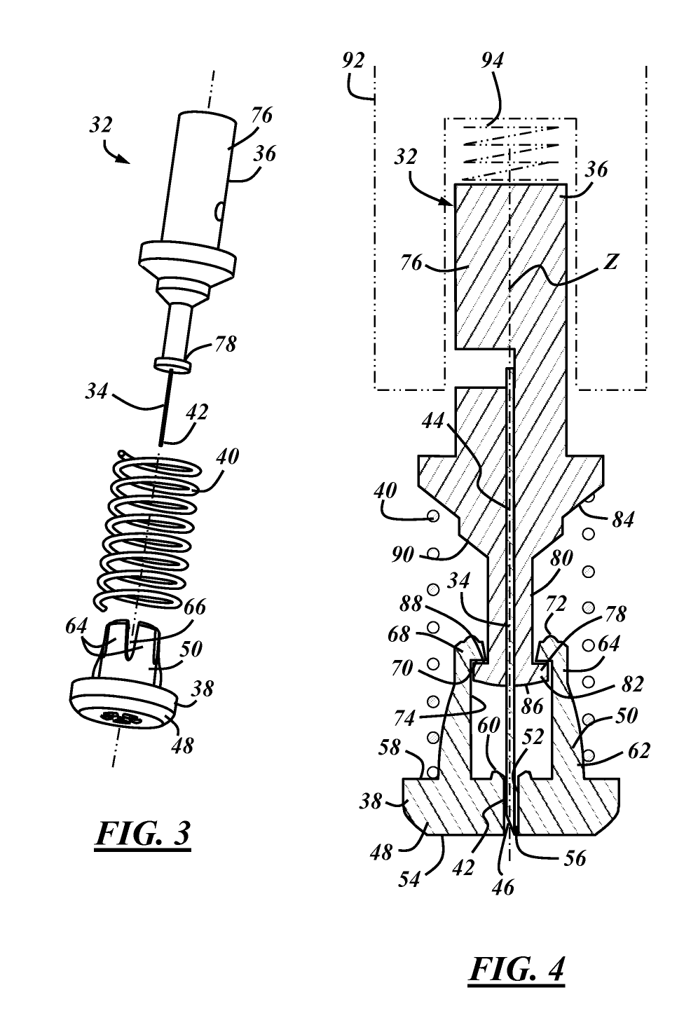

FIG. 3 is an exploded view of the piercing tool 32 of FIG. 2, and FIG. 4 is an enlarged cross-sectional view of the same piercing tool. Reference is made primarily to FIG. 4 to describe some of the features of this embodiment of the piercing tool 32, with some of the features numbered in FIG. 3 as well. The needle 34 includes the piercing end 42 and an opposite mounting end 44, with each of the needle ends arranged along an axis Z of the needle. The mounting end 44 of the needle 34 is attached to the needle mount 36 so that the needle and needle mount move together during operation. In this example, the mounting end 44 of the needle 34 is embedded in the material of the needle mount 36. In one embodiment, the needle mount 36 is made from a moldable plastic material and is overmolded onto the mounting end 44 of the needle 34. The needle 34 can be made from a steel alloy, such as stainless steel, or any other suitable material (e.g., titanium, nitinol, tungsten carbide, etc.). In the illustrated embodiment, the needle 34 has a solid cross-section, but the needle may alternatively have a tubular cross-section (e.g., a hypodermic needle). The piercing end 42 of the illustrated needle 34 includes a chamfer 46. Other piercing end configurations are possible, such as a conical end or a chisel end. In one embodiment, the piercing end 42 of the needle 34 includes a compound chamfer. As used herein, a compound chamfer includes at least one pair of chamfer surfaces arranged so that the surfaces are not symmetric with each other with respect to the needle axis Z. Compound chamfers and examples of suitable compound chamfers are described in greater detail in international patent application PCT/US2012/066293, which is hereby incorporated by reference in its entirety.

The housing 38 is coupled with the needle mount 36 for relative axial movement with respect to the needle mount between the retracted configuration and the extended configuration. The housing 38 is also configured to radially support the needle during needle movement and to restrict movement of the needle 34 to the axial direction, thereby preventing unwanted side-loading of the needle and enabling use of high gauge needles. In this example, the housing 38 includes a base 48, one or more walls 50 extending away from the base 48 in the axial direction and toward the needle mount 36, and a needle support surface 52. The housing 38 may be constructed from a moldable plastic material or any other suitable material. In the example in the figures, the housing 38 is coupled with the needle mount 36 in a snap-fit configuration. In this configuration, the needle mount 36 and needle 34 can be removed and replaced with a different needle mount and needle, such as a different gauge needle or an unused needle, with the housing 38 and/or the spring 40 being reusable.

The base 48 includes a face 54, an aperture 56, a spring biasing surface 58, and a first shoulder or positive stop 60. The face 54 is configured to contact the decorative covering during the piercing process and may have a relatively large surface area to distribute the force required to overcome the spring bias during needle movement toward the extended configuration over a relative large area. The aperture 56 is formed through the thickness of the base 48 and, in this case, is defined by the cylindrical support surface 52. The aperture 56 is sized to accommodate the needle 34 with sufficient clearance between the support surface 52 and the needle to allow free axial movement of the needle while restricting radial movement of the needle. In one embodiment, the aperture is sized to provide 0.05 mm clearance per side (0.1 mm on the diameter) between the needle 34 and the support surface 52. In another embodiment, the clearance per side is in a range from 10% to 25% of the needle diameter. The length of the aperture 56 (i.e., the thickness of the base 48 at the aperture) may range from 5 to 20 times the needle diameter or from 10 to 20 times the needle diameter. Where the piercing end 42 of the needle 34 includes the chamfer 46, the length of the aperture 56 is preferably greater than or equal to the chamfer length. The spring biasing surface 58 faces in the opposite direction from the face 54 and, in this case, is an annular surface surrounding the wall 50 of the housing 38. The first stop 60 is provided and located to help define the extension limit of the extended configuration of the piercing tool 32 and is an example of an internal positive stop that interacts with the needle mount 36 to limit the amount the piercing end 42 of the needle 34 can extend away from the housing 38.

The illustrated wall 50 includes a wall base 62 at the base 48 of the housing and a plurality of fingers 64 extending from the wall base in the axial direction with slots 66 (see FIG. 3) separating adjacent fingers from each other. In this example, the wall base 62 is generally cylindrical and coaxial with the needle 34. The wall base 62 may be sized to accommodate and/or locate the spring 40 as shown so that the spring is coaxial with the needle 34 as well. Alternatively, ribs or other features may extend radially from the wall base 62 to help locate and/or center the spring 40. The plurality of fingers 64 is arranged and uniformly spaced around the needle 34 in this example. Each of the plurality of fingers 64 is separately flexible in the illustrated snap-fit configuration to accommodate coupling and decoupling of the needle support 36 with the housing 38. The axial length of the slots 66 can be sized to provide the desired amount of flexibility of the fingers 64. Each of the fingers 64 may also include stiffening features such as ribs or embosses to affect their flexibility. Each of the fingers 64 extends between the wall base 62 and a snap tab 68 in the illustrated embodiment, and each snap tab 68 includes a second shoulder or stop 70. The second stop 70 is provided and located to help define the retracted configuration of the piercing tool 32 by interacting with the needle mount 36 as shown. The spring 40 biases the needle mount 36 against the second stop 70. Each of the fingers 64 has a distal end 72 that may be configured to function as a third stop. The third stop 72 functions in a manner similar to that of the first stop and is an example of an external positive stop that interacts with the needle mount 36 to limit the amount the piercing end 42 of the needle 34 can extend away from the housing 38. Together, the wall base 62 and the fingers 64 define a second support surface 74 that is coaxial with the needle 34. The support surface 74 provides radial support for the portion of the needle mount 36 that is captured between the first and second stops 60, 70 of the housing 38. The support surface 74 helps ensure that the portion of the needle 34 between the needle mount 36 and the aperture 56, which is not radially supported by the needle support surface 52, remains positioned along the needle axis Z during operation of the piercing tool 32. The support surface 74 is sized to allow free axial movement of the needle mount 36 while restricting its radial movement.

The illustrated needle mount 36 includes a fixture end 76, an opposite needle end 78, a shaft 80, a flange 82, a spring biasing surface 84, and first, second, and third shoulders or stops 86-90. The fixture end 76 is adapted for attachment to a mounting component 92 of a piercing fixture, jig, machine or system (e.g., a multi-axis robot or CNC equipment), shown in phantom in FIG. 4. The piercing system can be configured to move the piercing tool 32 as necessary among the desired microhole locations of the decorative covering and/or can be configured to accommodate a plurality of individual piercing tools. The needle 34 extends from the needle end 78, and the shaft 80 is located between the opposite ends 76, 78 of the needle mount 36. The shaft 80 is sized to fit within the fingers 64 and defines the distance between the second and third stops 88, 90 of the needle mount 36. The flange 82 is located at the needle end 78 of the needle mount 36 and is the portion of the needle mount captured between the first and second stops 60, 70 of the housing 38 and supported by the second support surface 74 of the housing. The spring biasing surface 84, the first stop 86, the second stop 88, and the third stop 90 are provided and configured to perform substantially the same functions as the corresponding biasing surface 48 and stops 60, 70, and 74 of the housing 38. The “first,” “second,” and “third” designations for the above-described stops are arbitrary and are provided to aid in description only. Each of the stops 60, 70, 74, 84, 86, 88 may be simply referred to as a stop or may be referred to with a designation other than the ones used in conjunction with the figures.

The spring 40 is a coil spring in the illustrated embodiment and is located between the respective spring biasing surfaces 48, 84 of the housing 38 and the needle mount 36. In the retracted configuration of FIG. 4, the spring 40 may be partially compressed (i.e., pre-loaded) so that respective second stops 70, 88 of the housing 38 and the needle mount 36 are in contact and biased against each other. The spring 40 includes any type of biasing element and may be in some other form than a coil spring. The spring 40 is coaxial with the needle 34. In embodiments where a plurality of needles 34 are included in the piercing tool 32 and/or as part of the piercing process, each needle 34 may be paired with a dedicated spring 40 so that each individual needle can be independently moved along the needle access and independently biased toward the retracted configuration. A dedicated spring 40 is a spring that functions to affect the bias of only a single needle. It is also possible for a single needle 34 to have more than one dedicated spring 40. This dedicated spring feature of the piercing tool 32, whether a single needle piercing tool or a multi-needle piercing tool, ensures a more uniform spring bias associated with each needle than if a single spring is used to bias multiple needles.

In one embodiment, the piercing tool 32 is adapted for biased attachment to the mounting component 92 of the piercing system. For instance, the attachment may be spring-loaded such that a spring 94 biases the piercing tool 32 against the piercing system, as shown in phantom in FIG. 4. This configuration can help reduce or prevent unwanted compression of the decorative covering during the piercing process, particularly when the piercing tool reaches the fully extended configuration from the retracted configuration such that the above-described stops of the piercing tool halt the relative movement between the housing and the needle. It has been found that in some cases, compression of the decorative covering causes the piercing end of the needle to extend further through the decorative covering (i.e., closer to the opposite surface of the covering) than it would if the covering did not compress. The resulting depth of each microhole may thus be larger than the amount the needle extends from the housing of the piercing tool in such cases and can sometimes result in the needle contacting the substrate of the panel in embodiments where the tear seam is formed in a covering already attached to the substrate (e.g., as in FIG. 2). The additional spring 94 can reduce the severity of the force spike when the stops of the piercing tool operate to halt the relative movement between the housing and the needle.

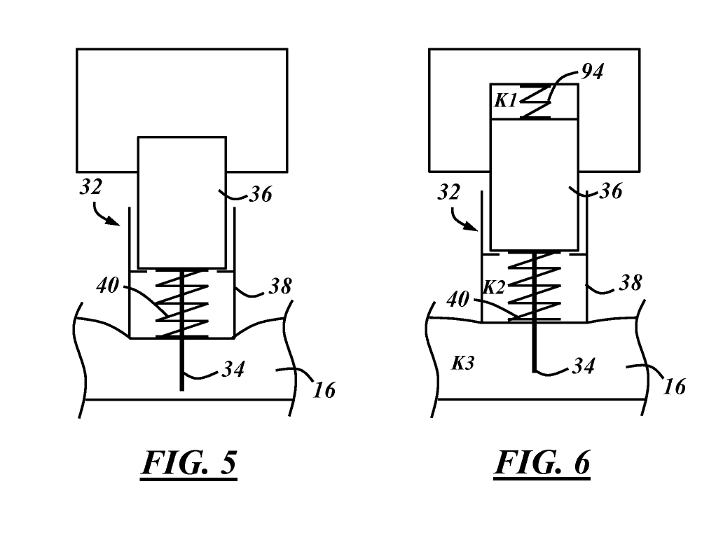

FIGS. 5 and 6 schematically illustrate the effect of a biased attachment of the piercing tool 32 to the piercing system. In FIG. 5, the piercing tool 32 is rigidly attached to the piercing system and is shown just after the extended configuration is reached. At this stage, additional movement of the piercing tool 32 toward the covering 16 after relative movement between the needle 34 and the housing 38 is halted results in compression of the covering. In FIG. 6, the piercing tool 32 is attached to the piercing system with a biased attachment, including spring 94 and is shown just after the extended configuration is reached. Here, additional movement of the piercing tool 32 toward the covering 16 after relative movement between the needle 34 and the housing 38 is halted results in compression of the spring 94. The spring constant (K1) of the spring 94 is preferably higher than the spring constant (K2) of the piercing tool spring 40, but lower than the effective spring constant (K3) of the decorative covering 16 (K2<K1<K3). The effective spring constant (K3) of the decorative covering is the amount of force require to compress the covering per unit thickness.

The above-described piercing tool, including radial support of the needle during the piercing process, has been tested and has proved capable of piercing at least 10,000 microholes in decorative coverings without bending the needle or otherwise requiring needle replacement, even with a 33-gauge needle. In experiments conducted without radial support for the needle (i.e., with the above-described piercing tool housing omitted) a 33-gauge needle with an exposed length of 18 mm was not capable of piercing a sufficient number of microholes to form a functional tear seam in a single decorative covering before bending. This increased needle longevity may force other needle failure modes, such as needle fatigue or dulling of the needle. One useful feature of some configurations of the above-described piercing tool is that it can be fabricated as a disposable piercing tool and/or as a piercing tool with a disposable and easily replaceable needle. For instance, the housing of the piercing tool can be designed to accommodate commercially available medical grade needles pre-molded with a needle mount, and a commercially available coil spring can be fit between the housing and needle mount to form the piercing tool.

Thus, one embodiment of the above-described piercing process may include the step of removing the needle from the piercing tool and replacing the needle with an unused needle if the piercing tool has previously been used to form the tear seam of a certain number of decorative coverings. In some cases, the needle may be replaced after forming the tear seam in only a single covering, such that each successive decorative covering undergoing the piercing process starts with an unused needle. In other cases, the needle may be replaced after forming the tear seam of 200 coverings. A useful life of the needle may be partly defined by the number of coverings undergoing the piercing process with the same needle. In one embodiment, the piercing process includes replacing the needle with an unused needle if the needle has been previously used to form the tear seam of a quantity of other decorative coverings. This quantity may be in a range from 1 to 200, from 10 to 200, from 10 to 100, from 10 to 50, or from 10 to 20 and may depend on factors such as needle replacement cost or other factors.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of making a vehicle interior panel for use over an airbag, comprising the steps of:
(a) providing a decorative covering having a decorative skin layer;
(b) forming a plurality of microholes through the decorative skin layer along a pre-determined tear seam location using a piercing tool that includes an individually extendable and retractable 26-gauge or higher gauge needle;
(c) radially supporting the needle during step (b) with a housing so that, during formation of each one of the microholes, the housing is in contact with the decorative covering and needle movement is restricted to axial movement; and
(d) disposing the decorative covering over a vehicle interior panel substrate.

2. The method of claim 1, wherein the piercing tool includes only one needle, and the same needle is used to form all of the microholes in the decorative covering along the tear seam location.

3. The method of claim 1, wherein step (d) is performed before steps (b) and (c).

4. The method of claim 3, wherein a face of the housing is in contact with the decorative covering during step (b) and the housing limits the amount of axial extension of the needle beyond the face of the housing.

5. The method of claim 4, wherein the piercing tool is attached to a piercing system via a biased attachment including a spring, the method further comprising the step of compressing the spring while the needle is at the limit of axial extension beyond the face of the housing.

6. The method of claim 1, wherein step (d) is performed after steps (b) and (c), and the decorative covering is flat during steps (b) and (c).

7. The method of claim 1, wherein the needle is a 33-gauge or higher gauge needle.

8. The method of claim 1, further comprising the step of replacing the needle with an unused needle before steps (b) and (c) if the needle has been previously used to form a plurality of microholes along the tear seam location of a quantity of other decorative coverings, wherein the quantity is in a range from 1 to 200.

9. A piercing tool for use in forming a tear seam in a vehicle interior panel, comprising:
a needle mount;
a needle having a piercing end and an opposite mounting end, each of the ends being arranged along an axis of the needle, wherein the mounting end of needle is attached to the needle mount so that the needle mount and the needle move together;
a housing coupled with the needle mount for relative axial movement with respect to the needle mount between a retracted configuration and an extended configuration, wherein the piercing end of the needle is inside the housing in the retracted configuration and the piercing end of the needle is outside the housing in the extended configuration, the housing being configured to radially support the needle during movement between the retracted and extended configurations; and
a spring that is dedicated to the needle and biases the needle mount toward the retracted configuration.

10. A piercing tool as defined in claim 9, wherein the needle is a 26-gauge or higher gauge needle.

11. A piercing tool as defined in claim 9, wherein the needle is a 33-gauge or higher gauge needle.

12. A piercing tool as defined in claim 9, wherein the spring is coaxial with the needle.

13. A piercing tool as defined in claim 9, wherein the housing is in contact with the needle mount at a first stop in the extended configuration and the housing is in contact with the needle mount at a second stop in the retracted configuration so that the axial spacing between the first and second stops defines the amount of allowable axial needle movement.

14. A piercing tool as defined in claim 13, wherein the housing is coupled with the needle mount in a snap-fit configuration that includes a plurality of separately flexible fingers spaced about the axis of the needle, wherein the plurality of fingers provides one of said stops.

15. A piercing tool as defined in claim 13, wherein the plurality of fingers is configured so that the needle mount and needle can be removed and replaced with a different needle mount and needle.

16. A piercing tool as defined in claim 9, wherein the needle includes a compound chamfer and a solid cross-section.
